(19) United States
(12) Patent Application Publication
(10) Pub. No.: US 2010/0030727 A1
(43) Pub. Date: Feb. 4, 2010

(54) Technique For Using Occurrence Constraints To Optimize XML Index Access

(76) Inventors: Sivasankaran Chandrasekar, Menlo Park, CA (US); Thomas Baby, Maple Valley, WA (US); Asha Tarachandani, Newark, CA (US); Nipun Agarwal, Santa Clara, CA (US)

Correspondence Address: HICKMAN PALERMO TRUONG & BECKER/ORACLE, 2055 GATEWAY PLACE, SUITE 550, SAN JOSE, CA, 95110-1083, US

(21) Appl. No.: 12/181,745

(22) Filed: Jul. 29, 2008

(51) Int. Cl. G06F 7/00; G06F 17/30

(52) U.S. Cl. 707/2; 707/E17.017

(57) ABSTRACT

Approaches are provided for improving the performance of certain database queries that operate on binary-encoded XML. In particular, the approach uses occurrence and type constraint information about XML data stored in the database for optimizing the relational rewrite of a query. Constraint information can be obtained in several different ways including through a formal language specification such as an XML Schema or DTD, through discovery of a user-provided secondary index on a an XML path table, or through a structural summary that is derived from statistical analysis on a set of XML documents stored in the database.

This application is related to U.S. application Ser. No. 10/884,311 entitled Index for Accessing XML Data filed on Jul. 2, 2004, the contents of which are herein incorporated by reference; to U.S. application Ser. No. 10/944,170 entitled Efficient Query Processing of XML Data Using XML Index filed on Sep. 16, 2004, the contents of which are herein incorporated by reference; to U.S. application Ser. No. 12/052,510 entitled Inferring Schemas From XML Document Collections filed on Mar. 20, 2008, the contents of which are herein incorporated by reference; and to U.S. application Ser. No. 11/184,302 entitled A Mechanism for Computing Structural Summaries of XML Document Collections in a Database System filed on Jul. 18, 2005, the contents of which are herein incorporated by reference.

### FIELD OF THE INVENTION

The present invention relates to database systems, and in particular, to optimization of queries that access XML data stored in a database system.

### BACKGROUND

Various types of storage mechanisms are used to store an XML document. One type of storage mechanism stores a XML document as a text file in a file system. Another type of mechanism for storing XML documents is a database server. In a database server, a XML document may be stored in a row of a table and nodes of the XML document are stored in separate columns in the row. An entire XML document may also be stored in a lob (large object) in a column. A XML document may also be stored as a hierarchy of objects in a database; each object is an instance of an object class and stores one or more elements of a XML document. Tables and/or objects of a database system that hold XML values are referred to herein as base tables or objects.

Such database servers include many mechanisms that allow for powerful and efficient ways to query large collections of XML documents. Database servers that store XML documents may be enhanced to efficiently perform XML operations using these mechanisms. One such type of XML operation is to execute queries over collections of XML documents using XML query languages, such as XQuery/XPath. XML Query Language (“XQuery”) and XML Path Language (“XPath”) are important standards for a query language, which can be used in conjunction with SQL to express a large variety of useful queries. The term XML query is used to refer to queries that conform to (1) XQuery, XPath, and/or another XML language standard, (2) SQL queries that may embed XQuery or XPath expressions, (3) queries of other languages, and (4) proprietary dialects of XQuery, XPath, SQL, or XML standard languages. When a database server receives an XML query, the database server may perform an XML rewrite to refer to the underlying database structures that store the XML data.

Relational operations on XML data stored in a database can be time consuming. Query transformations are important for optimizing performance of query execution on XML data. Described herein are techniques for using information about the XML data to write more effective query transformations.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow diagram showing the steps for using XML constraints to optimize XML re-write.

FIG. 2 is a diagram illustrating a computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Described herein are approaches for improving the performance of certain database queries that operate on XML data. In particular, the approach uses constraint information about XML data stored in the database for optimizing the relational rewrite of a query. The constraint information may describe any constraint or facet that XML standards provide for XML schemas. Standards governing XML schemas include: XML Schema, Part 0, Part 1, Part 2, W3C Recommendation, 2 May 2001, the contents of which are incorporated herein by reference; XML Schema Part 1: Structures, Second Edition, W3C Recommendation 28 Oct. 2004, the contents of which are incorporated herein by reference; XML Schema 1.1 Part 2: Datatypes, W3C Working Draft 17 Feb. 2006, the contents of which are incorporated herein by reference; and XML Schema Part 2: Datatypes Second Edition, W3C Recommendation 28 Oct. 2004, the contents of which incorporated herein by reference. XML Schemas as described in this document are not restricted to W3C XML Schemas but include any other mechanisms for describing the structural and/or typing information of XML documents, for example, Relax NG. Importantly, the source of the constraint information does not have to be a XML schema document.

According to an embodiment, there are two different kinds of constraints considered: occurrence constraints and data type constraints. An occurrence constraint is a constraint placed on the number of elements with a certain path that may exist in the same XML document. Knowing that at most one element exists at a certain path within any XML document allows optimizations to be made when performing the relational rewrite of a query.

A data type constraint limits the data type of a scalar element within an XML document, guaranteeing that all elements at a given path within a set of XML documents have the same data type. When the scalar data type of a simple element is known, the relational rewrite of a query over a set of XML documents may use index evaluation to speed up the resolution of the path expression.

### Operating Environment

A database comprises data and metadata that is stored on a persistent memory mechanism, such as a set of hard disks. Such data and metadata may be stored in a database logically, for example, according to relational and/or object-relational database constructs. Database applications interact with a database server by submitting to the database server commands that cause the database server to perform operations on data stored in a database. A database command may be in the form of a database statement. For the database server to process the database statements, the database statements must conform to a database language supported by the database server. One non-limiting database language supported by many database servers is SQL, including proprietary forms of SQL supported by such database servers as Oracle, (e.g. Oracle Database 10g). SQL data definition language (“DDL”) instructions are issued to a database server to create or configure database objects, such as tables, views, or complex data types.

Generally, data is stored in a database in one or more data containers, each container contains records, and the data within each record is organized into one or more fields. In relational database systems, the data containers are typically referred to as tables, the records are referred to as rows, and the fields are referred to as columns. In object oriented databases, the data containers are typically referred to as object classes, the records are referred to as objects, and the fields are referred to as attributes. Other database architectures may use other terminology. Systems that implement the present invention are not limited to any particular type of data container or database architecture. However, for the purpose of explanation, the examples and the terminology used herein shall be that typically associated with relational or object-relational databases. Thus, the terms “table”, “row” and “column” shall be used herein to refer respectively to the data container, record, and field.

A relational or object-relational database system may be extended to provide native support for storage, management, and query of (and thus function as a repository for) particular types of data. For example, a traditional relational database system may be augmented with features and technologies to enable storage of XML documents directly in the database, and access to such XML data in either an XML-centric (e.g., using XPath and the XQuery query language) or a relational-centric (e.g., using the SQL/XML query language) manner. Such a repository is at times referred to as an XML repository or an XML database (i.e., “XML DB”).

A database server may include a query optimizer responsible for generating an optimized execution plan to compute a query. A query optimizer may also optimize a query by transforming the query. In general, transforming a query involves rewriting a query into another query that should produce the same result and that can potentially be executed more efficiently, i.e. one for which a potentially more efficient and less costly execution plan can be generated. The query as transformed is referred to herein as the transformed query. The query is rewritten by manipulating a copy of the query representation to form a transformed query representation representing a transformed query.

During query optimization, a XML query referencing XML data may be rewritten to reference the base database objects and data structures that hold the XML data and/or to reference functions that are used to access these database objects and structures. This kind of transformation is called XML re-write.

### Use of XML Index

In order to speed up the access to binary encoded XML stored in the database as described above, an XML index can be used. A database server may maintain a “logical index”, which indexes a collection of XML documents. A logical index contains multiple structures that are cooperatively used to access another body of data a collection XML documents. A logical index includes a path table, which contains information about the hierarchies of nodes in a collection of XML documents and may contain the value of the nodes. Among the columns or attributes of the path table is a column that stores the path id of nodes. In an embodiment, a path id is a concatenation of tokens, each representing the name of a node in a path. However, in other embodiments, the path id may be any expression of a path, including a textual expression. In addition to the path table, a number of secondary indexes are created on the value column of the path table for locating rows in the path table by their value fields. Each value index operates on a different data type (eg. string, number, date, etc.) The XML index is described in greater detail in Index for Accessing XML Data (US Patent Publication 2005-0228792A1).

### Index Evaluation

In an index evaluation, an index is examined to determine which rows satisfy a particular condition. The result of an index evaluation can be the rows (or identity of rows) that satisfy the particular condition e.g. the row ids of the rows that have a key value that satisfy a condition.

When an XML Index is available for a set of documents, the SQL/XML operations are rewritten to cause index evaluation on the XML Index. Occurrence and type constraints can help to optimize the rewriting of queries using the most efficient index evaluation. There are at least three different ways in which constraint information enables index evaluation optimization. First, knowing the data type of an element enables the use of a secondary value index to speed up finding that element, where the value is more selective than the path id. Second, knowing that an XPath expression must evaluate to a single element can avoid unnecessary error checking when rewriting SQL/XML operations that require single element arguments. Third, translating SQL/XML operations on a known single value element can utilize more efficient relational operations on the XML Index. The following sections describe these optimizations in more detail.

### Rewriting extractValue

One of the SQL/XML operations is the extractValue function. extractValue takes an XPath expression as an argument and returns the scalar value of that expression. extractValue is defined to return an error if input path expression argument identifies more than one element. Thus, in the XML re-writing stage of query optimization, XML rewriting of extractValue requires generating code to check the number elements identified by an XPath expression and generating an error if more than one is returned. When there is a known guarantee that a particular XPath expression which is the input argument to extractValue can only identify a single element, that knowledge can be used to avoid generating code for and performing error checking when rewriting that instance of extractValue.

In addition to using occurrence constraints to optimize XML rewrite of extractValue, having data type information can optimize the rewrite as well. If the data type is known of the element that the XPath expression identifies, then the rewrite of extractValue can be written by performing index evaluation using the secondary index corresponding to the data type.

### Evaluating Predicates

Predicates may compare the values of nodes identified by an XPath expression. The expression may be evaluated by first identifying the rows in the XML path table that correspond to nodes that match the path expression, and then selecting from among those rows those have node values that satisfy the predicate. However, often it may be faster to select rows in the XML path table by first finding rows having a matching node value first, and then determining from among those rows those being associated with a path that matches the XPath expression. This latter technique will be more efficient when the value in the predicate being compared to the node value identifies fewer rows in the path table than using the path of the XPath expression as a key value.

A secondary index on the node values in the path table may be used to find rows that have matching values. There may be more than one secondary index on the values, each secondary index indexing values belonging of a particular data type. To use a secondary index, it may be necessary to know the data type of the values in order to know which secondary index to use. For example, if the predicate is (extractValue(‘/a/b/c’)=‘111108’), the value to match is ‘111108.’ If it can be determined that nodes that match the XPath expression have values that must be of a certain data type, then the secondary index for that database may be used to quickly find the rows in the path table having the matching value. Then, the path id's in each of the identified rows is compared against the path of the XPath expression.

In addition to exploiting the potential selectivity of finding values before paths, another optimization is recognizing when more efficient SQL operations may be utilized. In one embodiment where the predicate requires matching a node value, evaluating the predicate could be accomplished using a semi-join based on an exists subquery, where the subquery selects rows from the path table:

```
select * from XML path table
    where exists (select 1 from XML path table where node_value = “x”
    and path =”/a/b/c”)
```

A semi-join can be performed much more efficiently than an inner-join operation; however, it can only be used when there is a guarantee that only one row can be returned for each path.

### Discovering Constraints on the Data from an XML Source

Certain query optimizations can be performed when there is knowledge of constraints placed on the structure of the set of XML documents over which the query is executed. Two examples of constraints considered herein are occurrence constraints and data type constraints. Occurrence constraints indicate how many times an XML element may appear within a document. Knowing that an XML element must be unique within a document is an example of an occurrence constraint. The other constraint is a data type constraint. Knowing that an element is always a number is an example of a data type constraint.

There are several different ways for the query optimizer to learn about the occurrence and data type constraints of the XML data involved in a query. In one embodiment, an XML Schema, DTD, or other formal language description provide information about the required format for a set of conformant XML documents. For example, within an XML Schema when an element has an attribute “maxOccurs=1”, that element must be unique within the document. Furthermore, a data type definition expressed in a schema language indicates the data type of each simple XML element. For example, an element with an attribute of “type=integer” is defined to be a number.

Data type information can be inferred even without a formal description of the constraints to which a set of documents must comply. For example, it may be inferred from database metadata defining base structures that store XML documents. If a value index is created for a path within a collection of XML documents, the data type of that value index will enforce the data type of the element which the path identifies. Any time a new element is added, the indexing function will reject an element that is not of the expected data type. Thus, if it can be determined for a given path that there exists a value index that serves as a secondary index on the path table, then the path is guaranteed to identify an element of that same data type.

In yet another embodiment, the structure of a set of XML documents can be inferred empirically by analyzing the structure, data types, and other data properties of a set of XML documents. The results of the analysis are stored as a summary, such as the structural summary described in U.S. patent application Ser. No. 12/052,510 entitled, Inferring Schemas From XML Document Collections. The structural summary may indicate, among other kinds of information, occurrence constraints and data type constraints of elements in the collection of XML documents.

### Using Knowledge of Constraints to Optimize Execution Plan

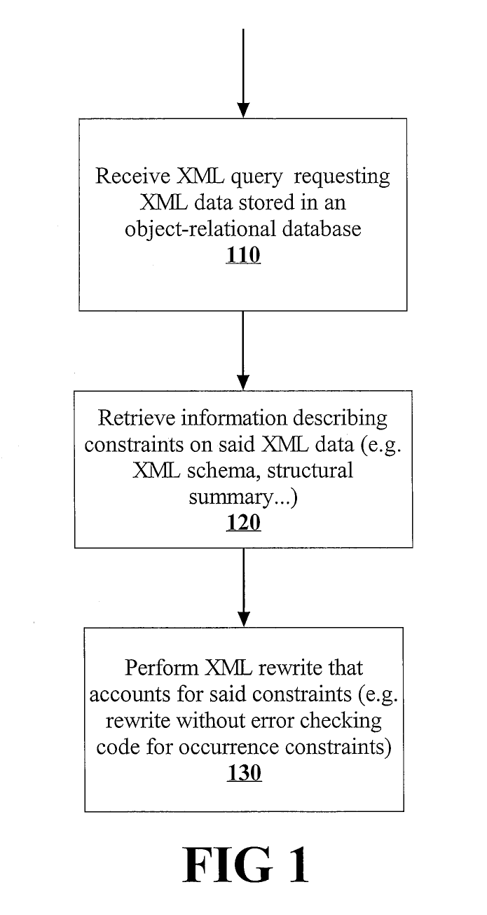

FIG. 1 shows a flow diagram showing an overview of the steps performed to optimize XML rewrite using constraint information. First, an database query is received that requires the retrieval of XML data stored in the database (Step 110). Next, constraint information is retrieved (Step 120). The constraint information may be obtained through a formal description of the XML data structure, through a structural summary, implicitly through the presence of certain secondary indexes. Knowledge of the constraint information guides the query re-writing process to be optimized (Step 130). For example, as mentioned earlier, the generation of certain error checking and handling code can be avoided when the argument to a query operation is guaranteed to be single valued. Also, knowing the data type of an xml element allows code generation that utilizes the appropriate secondary value index for a more selective, and thus more efficient, index evaluation.

### Hardware Overview

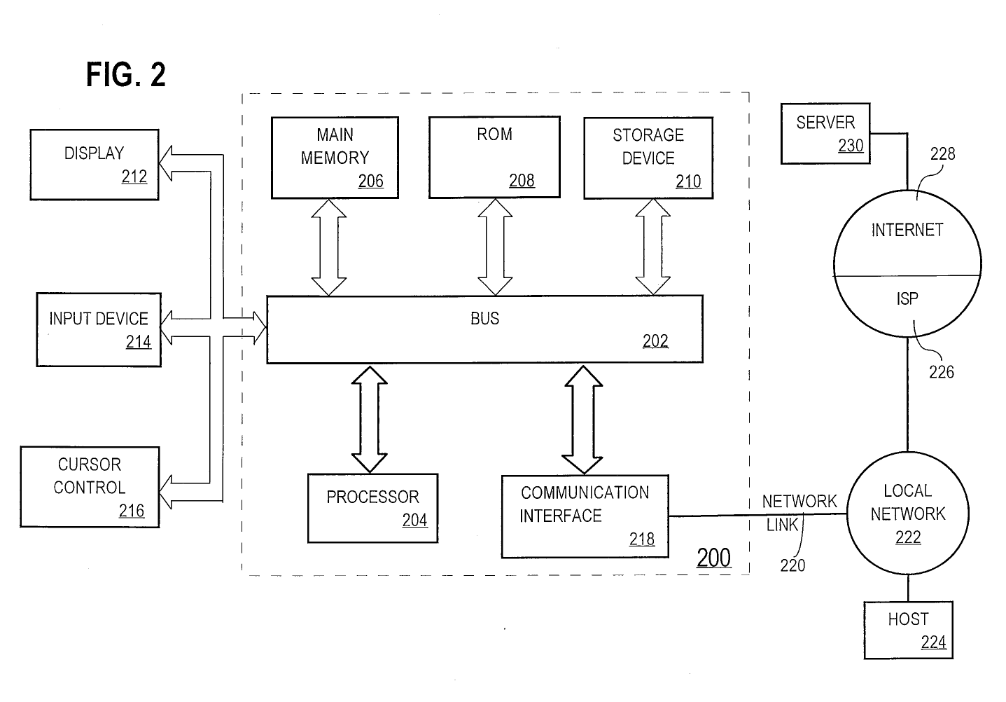

FIG. 2 is a block diagram that illustrates a computer system 200 upon which an embodiment of the invention may be implemented. Computer system 200 includes a bus 202 or other communication mechanism for communicating information, and a processor 204 coupled with bus 202 for processing information. Computer system 200 also includes a main memory 206, such as a random access memory (RAM) or other dynamic storage device, coupled to bus 202 for storing information and instructions to be executed by processor 204. Main memory 206 also may be used for storing temporary variables or other intermediate information during execution of instructions to be executed by processor 204. Computer system 200 further includes a read only memory (ROM) 208 or other static storage device coupled to bus 202 for storing static information and instructions for processor 204. A storage device 210, such as a magnetic disk or optical disk, is provided and coupled to bus 202 for storing information and instructions.

Computer system 200 may be coupled via bus 202 to a display 212, such as a cathode ray tube (CRT), for displaying information to a computer user. An input device 214, including alphanumeric and other keys, is coupled to bus 202 for communicating information and command selections to processor 204. Another type of user input device is cursor control 216, such as a mouse, a trackball, or cursor direction keys for communicating direction information and command selections to processor 204 and for controlling cursor movement on display 212. This input device typically has two degrees of freedom in two axes, a first axis (e.g., x) and a second axis (e.g., y), that allows the device to specify positions in a plane.

The invention is related to the use of computer system 200 for implementing the techniques described herein. According to one embodiment of the invention, those techniques are performed by computer system 200 in response to processor 204 executing one or more sequences of one or more instructions contained in main memory 206. Such instructions may be read into main memory 206 from another machine-readable medium, such as storage device 210. Execution of the sequences of instructions contained in main memory 206 causes processor 204 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 200, various machine-readable media are involved, for example, in providing instructions to processor 204 for execution. Such a medium may take many forms, including but not limited to storage media and transmission media. Storage media includes both non-volatile media and volatile media. Non-volatile media includes, for example, optical or magnetic disks, such as storage device 210. Volatile media includes dynamic memory, such as main memory 206. Transmission media includes coaxial cables, copper wire and fiber optics, including the wires that comprise bus 202. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 204 for execution. For example, the instructions may initially be carried on a magnetic disk of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector can receive the data carried in the infra-red signal and appropriate circuitry can place the data on bus 202. Bus 202 carries the data to main memory 206, from which processor 204 retrieves and executes the instructions. The instructions received by main memory 206 may optionally be stored on storage device 210 either before or after execution by processor 204.

Computer system 200 also includes a communication interface 218 coupled to bus 202. Communication interface 218 provides a two-way data communication coupling to a network link 220 that is connected to a local network 222. For example, communication interface 218 may be an integrated services digital network (ISDN) card or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic or optical signals that carry digital data streams representing various types of information.

Network link 220 typically provides data communication through one or more networks to other data devices. For example, network link 220 may provide a connection through local network 222 to a host computer 224 or to data equipment operated by an Internet Service Provider (ISP) 226. ISP 226 in turn provides data communication services through the world wide packet data communication network now commonly referred to as the “Internet” 228. Local network 222 and Internet 228 both use electrical, electromagnetic or optical signals that carry digital data streams. The signals through the various networks and the signals on network link 220 and through communication interface 218, which carry the digital data to and from computer system 200, are exemplary forms of carrier waves transporting the information.

Computer system 200 can send messages and receive data, including program code, through the network(s), network link 220 and communication interface 218. In the Internet example, a server 230 might transmit a requested code for an application program through Internet 228, ISP 226, local network 222 and communication interface 218.

The received code may be executed by processor 204 as it is received, and/or stored in storage device 210, or other non-volatile storage for later execution. In this manner, computer system 200 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method, comprising:
determining one or more constraints from first data reflecting value constraints of a collection of XML documents; and
determining how to perform a relational rewrite of a query based on said first data.

2. The method of claim 1,
wherein an XML path table contains entries, each entry corresponding to a node in said collection of XML documents and containing a path expression and a value of said node;
wherein an index on said XML path table indexes said XML path table by the values in the entries;
wherein said one or more constraints constrain an element to a single occurrence within an XML document;
wherein a predicate in said query is based on the value element in said collection of XML documents; and
wherein determining how to perform a relational rewrite includes determining whether to use an index evaluation based on said index to evaluate said predicate.

3. The method of claim 2, wherein the first data reflecting value constraints are based on an XML schema representing the structure of the set of XML documents.

4. The method of claim 1, wherein the first data reflecting value constraints are based on a structural summary derived from the set of XML documents.

5. The method of claim 2, wherein determining how to perform a relational rewrite further comprises:
determining the existence of an index on said XML path table, wherein the predicate of said query is based on a path expression and said index indexes said path expression on said XML path table; and
using said index to perform the relational rewrite.

6. A computer-implemented method, comprising:
determining one or more constraints from first data reflecting occurrence constraints of a collection of XML documents; and
determining how to perform a relational rewrite of a query based on said first data.

7. The method of claim 6,
wherein an XML path table contains entries, each entry corresponding to a node in said collection of XML documents and containing a path expression and a value of said node;
wherein an index on said XML path table indexes said XML path table by the values in the entries;
wherein said one or more constraints constrain an element to a single occurrence within an XML document;
wherein a predicate in said query is based on the value element in said collection of XML documents; and
wherein determining how to perform a relational rewrite includes determining whether to use an index evaluation based on said index to evaluate said predicate.

8. The method of claim 6, wherein the first data reflecting occurrence constraints are based on an XML schema representing the structure of the set of XML documents.

9. The method of claim 6, wherein the first data reflecting occurrence constraints are based on a summary derived from the set of XML documents.

10. The method of claim 6, wherein determining how to perform a relational rewrite further comprises:
determining the existence of an index on said XML path table, wherein the predicate of said query is based on a path expression and said index indexes said path expression on said XML path table; and
using said index to perform the relational rewrite.

11. A computer-readable storage medium storing one or more sequences of instructions which, when executed by one or more processors, causes the one or more processors to perform the method recited in claim 1.

12. A computer-readable storage medium storing one or more sequences of instructions which, when executed by one or more processors, causes the one or more processors to perform the method recited in claim 2.

13. A computer-readable storage medium storing one or more sequences of instructions which, when executed by one or more processors, causes the one or more processors to perform the method recited in claim 3.

14. A computer-readable storage medium storing one or more sequences of instructions which, when executed by one or more processors, causes the one or more processors to perform the method recited in claim 4.

15. A computer-readable storage medium storing one or more sequences of instructions which, when executed by one or more processors, causes the one or more processors to perform the method recited in claim 5.

16. A computer-readable storage medium storing one or more sequences of instructions which, when executed by one or more processors, causes the one or more processors to perform the method recited in claim 6.

17. A computer-readable storage medium storing one or more sequences of instructions which, when executed by one or more processors, causes the one or more processors to perform the method recited in claim 7.

18. A computer-readable storage medium storing one or more sequences of instructions which, when executed by one or more processors, causes the one or more processors to perform the method recited in claim 8.

19. A computer-readable storage medium storing one or more sequences of instructions which, when executed by one or more processors, causes the one or more processors to perform the method recited in claim 9.

20. A computer-readable storage medium storing one or more sequences of instructions which, when executed by one or more processors, causes the one or more processors to perform the method recited in claim 10.
